(19) United States
(12) Patent Application Publication
(10) Pub. No.: US 2021/0037061 A1
(43) Pub. Date: Feb. 4, 2021

(54) MANAGING MACHINE LEARNED SECURITY FOR COMPUTER PROGRAM PRODUCTS

(71) Applicant: AT&T Intellectual Property I, L.P., Atlanta, GA (US)

(72) Inventors: William R. Trost, Mequon, WI (US); Chad Hiestand, Winfield, IL (US); David FengLin Chen, Fremont, CA (US); Anthony Librera, Palm Harbor, FL (US); Brian Miles, Pittsboro, IN (US)

(21) Appl. No.: 16/527,409

(22) Filed: Jul. 31, 2019

(51) Int. Cl. H04L 29/06; G06N 20/00

(52) U.S. Cl. CPC H04L 63/205; G06N 20/00; H04L 63/1425

(57) ABSTRACT

Methods, systems, and apparatuses, may manage machine learned security for computer program products, which may create dynamic micro-perimeters.

### BACKGROUND

Communication networks have migrated from using specialized networking equipment executing on dedicated hardware, like routers, firewalls, and gateways, to software defined networks (SDNs) executing as virtualized network functions (VNF) in a cloud infrastructure. To provide a service, a set of VNFs may be instantiated on the general-purpose hardware. Each VNF may require one or more virtual machines (VMs) to be instantiated. In turn, VMs may require various resources, such as memory, virtual central processing units (vCPUs), and network interfaces or network interface cards (NICs). Cloud systems are complex multi-layer hardware and software systems that consist of multiple components, interacting with each other through complicated mechanisms. The operation and management of a large-scale cloud is highly susceptible to anomalies, attacks, and faults. Identifying the root causes is often difficult to diagnose even with the skilled operators. This disclosure is directed to addressing issues in the existing technology.

### SUMMARY

Methods, systems, and apparatuses, among other things, may provide for managing machine learned security for computer program products, which may create dynamic micro-perimeters.

In an example, an apparatus may include a processor and a memory coupled with the processor that effectuates operations. The operations may include obtaining a log of data traffic, wherein the log of data traffic may include information associated with a first application; analyzing the log of data traffic using the machine learning model; determining, based on the analysis used by the machine learning model, whether to alter security rules for the first application; and based on the determination to alter the security rules for the first application, sending instructions to alter the security rules for the first application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system that may implement management of machine learned security for computer program products.

FIG. 2 illustrates an exemplary method for managing of machine learned security for computer program products.

FIG. 3 illustrates a schematic of an exemplary network device.

FIG. 4 illustrates an exemplary communication system that provides wireless telecommunication services over wireless communication networks.

FIG. 5A is a representation of an exemplary network.

FIG. 5B is a representation of an exemplary hardware platform for a network.

### DETAILED DESCRIPTION

In any modern business information technology enterprise, commonly, applications interact and coexist on flat computer networks. Flat networks allow computer traffic to traverse east to west without restriction. While traditional network controls may be employed to attempt to monitor and control northbound to southbound network traffic to prevent intrusion from the internet and curtail malicious attacks from bad actors outside the network boundaries. This flat network architecture, if compromised, lends itself to potentially devastating consequences that can adversely affect a corporate entities ability to operate. Even when proper controls are in place, this is often a dynamic landscape with thousands of employees, contractors, and customers accessing our systems. This ever-changing environment requires frequent updates and that may simply be out of the realm of human responsiveness.

For applications in the Cloud, Cloud service providers already provide basic network security such as firewalling. Any access control that was previously implemented at the network level may be more secure if moved to the application level. By shrinking the security perimeter to address each individual application, a user's access to the application may be controlled in a more secure manner without having to rely on a cumbersome virtual private network connection or the like. Disclosed herein is a framework for managing micro-perimeters around applications.

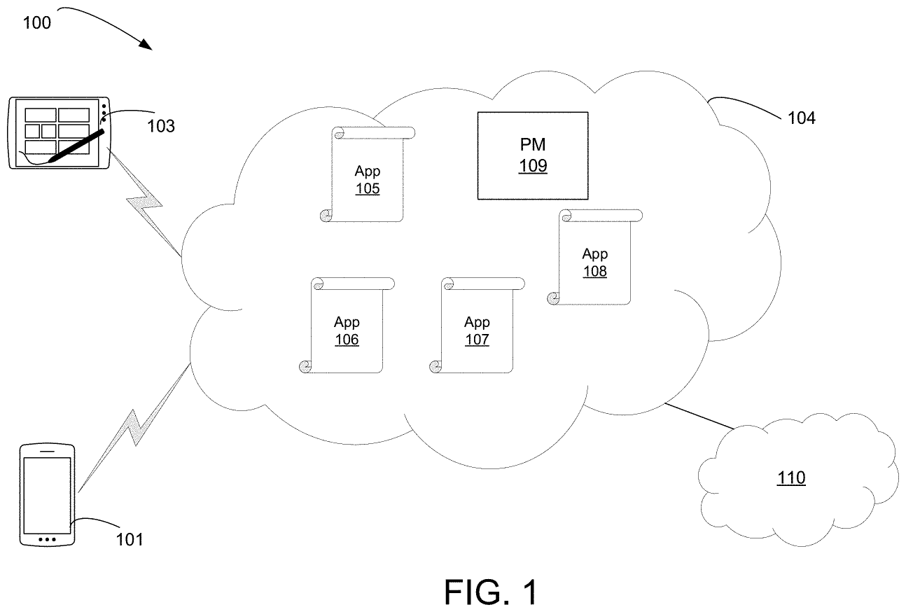

FIG. 1 illustrates an exemplary system that may implement management of machine learned security for computer program products (e.g., applications). System 100 may include mobile phone 101 and tablet device 103 that may connect with cloud network 104. Cloud network 104 or cloud network 103 may include multiple physical and virtual devices that may be communicatively connected with each other. As shown, cloud network 104 may include App 105 (i.e., application 105), App 106, App 107, App 108, or policy manager (PM) 109, which may be communicatively connected with each other. Cloud network 103 may have applications that are different or similar to the applications of cloud network 104. The applications and PM 109 may be located one device (physical or virtual) or distributed over multiple devices. For example, App 105 and App 106 may be on the same device or may have dedicated devices for each. The applications may be secured by firewall-like entities that may be physical entities or virtual entities (e.g., virtual machine or virtual network functions). PM 109 may coordinate the security among App 105-App 108, mobile phone 101, or tablet 103, which may alter the traffic flow or execution of commands between or within applications or devices (e.g., App 105-App 108, mobile phone 101, or tablet 103).

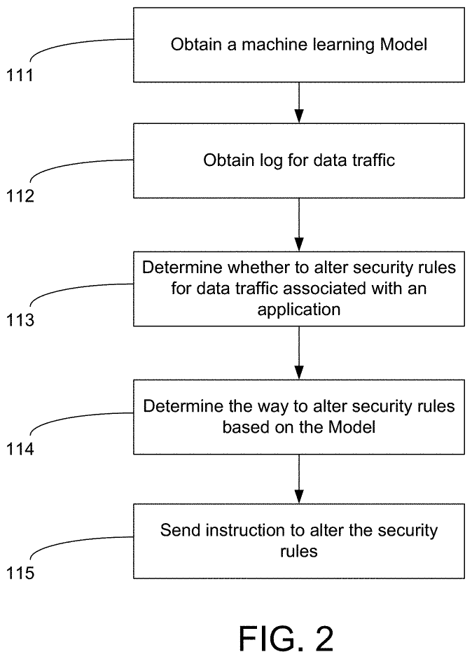

FIG. 2 illustrates an exemplary method for managing of machine learned security for computer program products. At step 111, a machine learning model (also referred to as “model”) may be obtained (e.g., selected or received) by PM 109. The machine learning model may have been selected from a plurality of machine learning models, such as linear regression, logistic regression, neural networks, decision tree, support vector machine (SVM), naive bayes, k-Nearest Neighbors (kNN), k-means, or random forest, among others. PM 109 may obtain a first model (e.g., decision tree) for a first period and after a threshold period another machine learning model may be selected. Alternative selection methods are disclosed in more detail herein.

At step 112, data traffic or log of data traffic may be obtained by PM 109. The data traffic may be data that is passed between applications or other associated devices for performing a service. The log of data traffic may be for one or more application in cloud network 104. The log of data traffic may be obtained periodically (e.g., every 5 or 10 minutes) and may include information such as data traffic flow (or lack thereof) among App 105-App 108, mobile phone 101, or tablet 103. Other information may include errors, timestamps of events, type of application, current micro-perimeters (e.g., application or virtual machine specific data security), performance indicators (e.g., errors, throughput, downtime, processing, or memory that may be attributed to an application), NetFlows, packet capture files, a vulnerability stream (threat stream), opened sockets, or listening sockets, among other things. It is contemplated that only a percentage of the logs (e.g., 10%) of each application may be obtained by PM 109.

At step 113, the selected model of step 111 may analyze the obtained data traffic of step 112 in order to determine whether to alter the data security associated with an application or device. At step 114, when it is determined that the data security should be altered, then the model may be used to further determine how to alter the data security. Altering the data security may include altering the traffic flow (e.g., allow or deny the routing of traffic from App 105 to App 106, reroute the traffic from App 105 to App 106 through App 107, or reroute the traffic of App 105 to App 108 rather than App 106.). Altering the data security may include not allowing certain commands to be executed for or within an application (e.g., App 105), in which the commands may be data traffic from another application (e.g., App 106). At step 115, PM 109 may provide instructions to App 105-App 108, mobile phone 101, tablet 103, virtual firewalls (not shown), or physical firewalls (not shown), among other devices. It is contemplated that App 105-App 108 may have an application programming interface (API) or other software tool that may be used to accommodate such changes in data security. There may be an API that helps restrict execution of a particular command (or data traffic type) received, restricts any traffic received from a particular application (or network), restricts sending of a particular command to be executed to a particular application or network (or type of application or network). Authorization may be time period based. PM 109 may manage data sets with policies that may be directly implemented by one or more client applications.

With continued reference to the method of FIG. 2, a machine learning model may be updated based on performance. Some machine learning models may perform better (e.g., predict negative or positive outcomes) than other machine learning models as a network evolves. A network may evolve based on the addition or removal of different applications or a change in communication patterns between applications (e.g., communication switches to between App 105 and App 108 instead of between App 105 and App 106). In an example, PM 109 may use historical input data at period one to test the performance of each model in predicting corresponding historical output data (e.g., historical outcomes of errors or malicious activities or lack thereof) and if it is determined that a new model would outperform an existing model by a threshold amount (e.g., greater than 1% difference between models in predicting historical outcomes), then PM 109 may dynamically switch to the new model (e.g., for use in step 113 and step 114) at a subsequent period. Historical input data or output data may include previous real data traffic or logs of data traffic App 105-App 108, mobile phone 101, or tablet 103.

For additional perspective, in an example scenario, App 105 may often (e.g., every 5 minutes or less) send several types of traffic to App 106, but App 105 may rarely (e.g., every 2 days or more) send traffic to App 107. When App 106 does send traffic to App 107, it may be a particular type of traffic, such as a query to synchronize its clock. Similar Apps may be in cloud 104 (not shown) or cloud 104 operating in similar manner. A selected machine learning model of PM 109 may be used to determine that an alert should be created if other traffic is sent to App 107 from App 105 that is more often than usual (e.g., traffic every hour) and a different type of traffic than before. If App 107 or App 105 starts having abnormal errors or performance issues after receiving sending the different traffic within this alerted period, then PM 109 may propagate instructions to not allow the different traffic for App 105 or App 107 and for any similar application communication in cloud 104 and neighboring cloud 110. In another example scenario, PM 109 based on the selected model may determine that every time a certain command is executed on App 105 or App 107, there are errors or outages. Therefore PM 109 may send instructions to App 105 or App 107 to deny the execution of the certain command.

Disclosed herein are method, systems, and apparatus to dynamically create, update, or delete data security rules (e.g., firewall rules) deployed on a security entity (e.g., virtual machine, virtual network function, API, or physical firewall) so as to build micro-perimeter around these applications. The dynamic micro-perimeter creation, update, or deletion disclosed herein may be incorporated into software defined network (SDN) domain 2 or domain 3 whitebox cluster implementations.

Rather than or in addition to having a peripheral firewall that if breached leaves the entire system vulnerable, now dynamic micro-perimeters may be used to protect each service. So, even if one of the services is breached, the others may remain secure. The use of machine learning techniques as applied to cybersecurity, however, is in its infancy and therefore has ample opportunity for innovation. This disclosed subject may address the needs to continually identify, manipulate, and generate security policy to protect network end points and elements in a dynamic and autonomous manner utilizing advanced machine learning models and techniques. The disclosed subject matter may allow for perpetual learning, responding, and re-learning when protecting network end points and elements without continual human intervention. Deep learning models may be employed to identify network traffic patterns with the intent to create, evaluate, or manipulate endpoint (e.g., application or virtual machine) security policies through automated orchestration in response to changing network conditions and threats. A policy manager may consume network traffic information in real time and may interact with a machine learning model to dynamically generate security policies (also referred herein as security rules or data security). These models may be extended for threat detection; thus, offering additional network protections. This micro-segmentation (e.g., micro-perimeter) approach may mitigate the threat vector of a flat-network. Moreover, these models can be trained in a separate environment and pushed to production where the policy generation client automatically detects the new model and deploys it. Since machine learning models can “learn” from the training data, this may eliminate the need for a developer to manually make coding changes. This can all be accomplished in an automated fashion further reducing the dependency on manual processes and provide near real time responses.

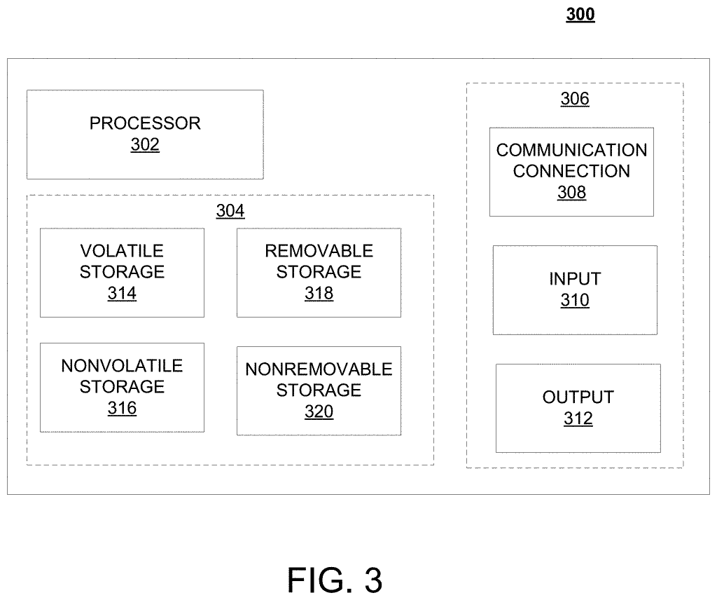

FIG. 3 is a block diagram of network device 300 that may be connected to or comprise a component of system 100. Network device 300 may comprise hardware or a combination of hardware and software. The functionality to facilitate telecommunications via a telecommunications network may reside in one or combination of network devices 300. Network device 300 depicted in FIG. 3 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 3 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength. As evident from the description herein, network device 300 is not to be construed as software per se.

In addition to processor 302 and memory 304, network device 300 may include an input/output system 306. Processor 302, memory 304, and input/output system 306 may be coupled together (coupling not shown in FIG. 3) to allow communications between them. Each portion of network device 300 may comprise circuitry for performing functions associated with each respective portion. Thus, each portion may comprise hardware, or a combination of hardware and software. Accordingly, each portion of network device 300 is not to be construed as software per se. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

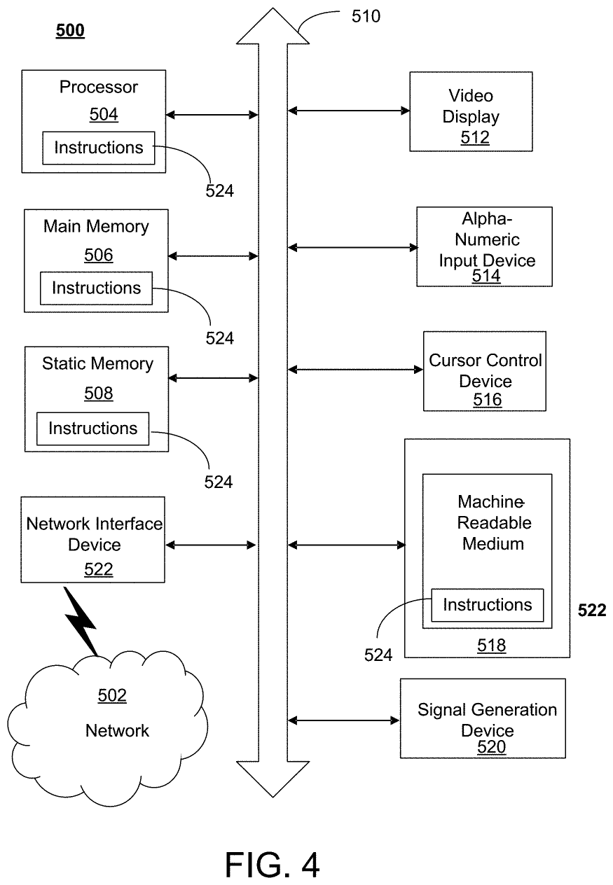

FIG. 4 depicts an exemplary diagrammatic representation of a machine in the form of a computer system 500 within which a set of instructions, when executed, may cause the machine to perform any one or more of the methods described above. One or more instances of the machine can operate, for example, as processor 302, PM 109, mobile phone 101, tablet 103, and other devices of FIG. 1. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

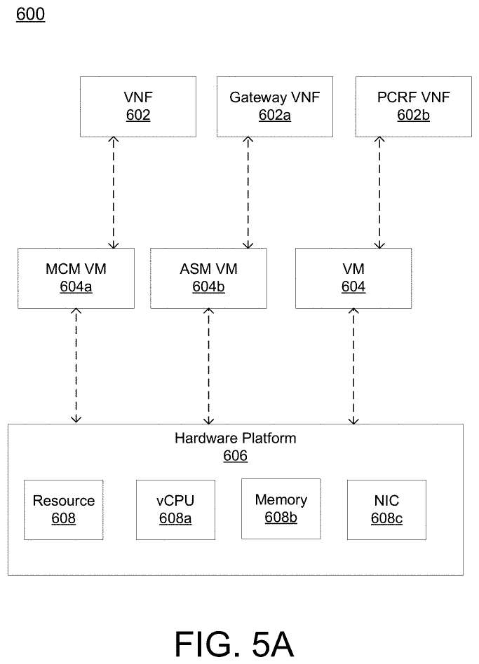

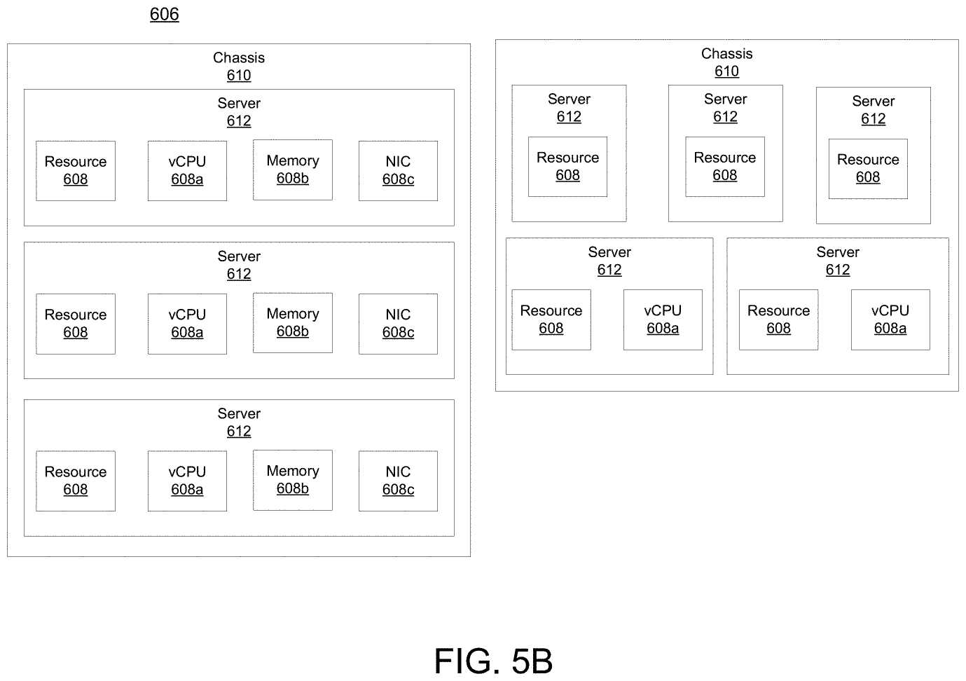

FIG. 5A is a representation of an exemplary network 600. Network 600 (e.g., cloud network 103 or cloud network 104) may include a software-defined network. For example, network 600 may include one or more virtualized functions implemented on general purpose hardware, such as in lieu of having dedicated hardware for every network function. That is, general purpose hardware of network 600 may be configured to run virtual network elements to support communication services, such as mobility services, including consumer services and enterprise services. These services may be provided or measured in sessions.

A virtual network functions (VNFs) 602 may be able to support a limited number of sessions. Each VNF 602 may have a VNF type that indicates its functionality or role. For example, FIG. 5A illustrates a gateway VNF 602a and a policy and charging rules function (PCRF) VNF 602b. Additionally or alternatively, VNFs 602 may include other types of VNFs. Each VNF 602 may use one or more virtual machines (VMs) 604 to operate. Each VM 604 may have a VM type that indicates its functionality or role. For example, FIG. 5A illustrates a management control module (MCM) VM 604a and an advanced services module (ASM) VM 604b. Additionally or alternatively, VMs 604 may include other types of VMs, such as a DEP VM (not shown). Each VM 604 may consume various network resources from a hardware platform 606, such as a resource 608, a virtual central processing unit (vCPU) 608a, memory 608b, or a network interface card (NIC) 608c. Additionally or alternatively, hardware platform 606 may include other types of resources 608.

While FIG. 5A illustrates resources 608 as collectively contained in hardware platform 606, the configuration of hardware platform 606 may isolate, for example, certain memory 608c from other memory 608c. FIG. 5B provides an exemplary implementation of hardware platform 606.

Hardware platform 606 may comprise one or more chasses 610. Chassis 610 may refer to the physical housing or platform for multiple servers or other network equipment. In an aspect, chassis 610 may also refer to the underlying network equipment. Chassis 610 may include one or more servers 612. Server 612 may comprise general purpose computer hardware or a computer. In an aspect, chassis 610 may comprise a metal rack, and servers 612 of chassis 610 may comprise blade servers that are physically mounted in or on chassis 610.

Each server 612 may include one or more network resources 608, as illustrated. Servers 612 may be communicatively coupled together (not shown) in any combination or arrangement. For example, all servers 612 within a given chassis 610 may be communicatively coupled. As another example, servers 612 in different chasses 610 may be communicatively coupled. Additionally or alternatively, chasses 610 may be communicatively coupled together (not shown) in any combination or arrangement.

The characteristics of each chassis 610 and each server 612 may differ. For example, FIG. 5B illustrates that the number of servers 612 within two chasses 610 may vary. Additionally or alternatively, the type or number of resources 610 within each server 612 may vary. In an aspect, chassis 610 may be used to group servers 612 with the same resource characteristics. In another aspect, servers 612 within the same chassis 610 may have different resource characteristics.

Given hardware platform 606, the number of sessions that may be instantiated may vary depending upon how efficiently resources 608 are assigned to different VMs 604. For example, assignment of VMs 604 to particular resources 608 may be constrained by one or more rules. For example, a first rule may require that resources 608 assigned to a particular VM 604 be on the same server 612 or set of servers 612. For example, if VM 604 uses eight vCPUs 608a, 1 GB of memory 608b, and 2 NICs 608c, the rules may require that all of these resources 608 be sourced from the same server 612. Additionally or alternatively, VM 604 may require splitting resources 608 among multiple servers 612, but such splitting may need to conform with certain restrictions. For example, resources 608 for VM 604 may be able to be split between two servers 612. Default rules may apply. For example, a default rule may require that all resources 608 for a given VM 604 must come from the same server 612.

An affinity rule may restrict assignment of resources 608 for a particular VM 604 (or a particular type of VM 604). For example, an affinity rule may require that certain VMs 604 be instantiated on (that is, consume resources from) the same server 612 or chassis 610. For example, if VNF 602 uses six MCM VMs 604a, an affinity rule may dictate that those six MCM VMs 604a be instantiated on the same server 612 (or chassis 610). As another example, if VNF 602 uses MCM VMs 604a, ASM VMs 604b, and a third type of VMs 604, an affinity rule may dictate that at least the MCM VMs 604a and the ASM VMs 604b be instantiated on the same server 612 (or chassis 610). Affinity rules may restrict assignment of resources 608 based on the identity or type of resource 608, VNF 602, VM 604, chassis 610, server 612, or any combination thereof.

An anti-affinity rule may restrict assignment of resources 608 for a particular VM 604 (or a particular type of VM 604). In contrast to an affinity rule—which may require that certain VMs 604 be instantiated on the same server 612 or chassis 610—an anti-affinity rule requires that certain VMs 604 be instantiated on different servers 612 (or different chasses 610). For example, an anti-affinity rule may require that MCM VM 604a be instantiated on a particular server 612 that does not contain any ASM VMs 604b. As another example, an anti-affinity rule may require that MCM VMs 604a for a first VNF 602 be instantiated on a different server 612 (or chassis 610) than MCM VMs 604a for a second VNF 602. Anti-affinity rules may restrict assignment of resources 608 based on the identity or type of resource 608, VNF 602, VM 604, chassis 610, server 612, or any combination thereof.

Within these constraints, resources 608 of hardware platform 606 may be assigned to be used to instantiate VMs 604, which in turn may be used to instantiate VNFs 602, which in turn may be used to establish sessions. The different combinations for how such resources 608 may be assigned may vary in complexity and efficiency. For example, different assignments may have different limits of the number of sessions that can be established given a particular hardware platform 606.

For example, consider a session that may require gateway VNF 602a and PCRF VNF 602b. Gateway VNF 602a may require five VMs 604 instantiated on the same server 612, and PCRF VNF 602b may require two VMs 604 instantiated on the same server 612. (Assume, for this example, that no affinity or anti-affinity rules restrict whether VMs 604 for PCRF VNF 602b may or must be instantiated on the same or different server 612 than VMs 604 for gateway VNF 602a.) In this example, each of two servers 612 may have enough resources 608 to support 10 VMs 604. To implement sessions using these two servers 612, first server 612 may be instantiated with 10 VMs 604 to support two instantiations of gateway VNF 602a, and second server 612 may be instantiated with 9 VMs: five VMs 604 to support one instantiation of gateway VNF 602a and four VMs 604 to support two instantiations of PCRF VNF 602b. This may leave the remaining resources 608 that could have supported the tenth VM 604 on second server 612 unused (and unusable for an instantiation of either a gateway VNF 602a or a PCRF VNF 602b). Alternatively, first server 612 may be instantiated with 10 VMs 604 for two instantiations of gateway VNF 602a and second server 612 may be instantiated with 10 VMs 604 for five instantiations of PCRF VNF 602b, using all available resources 608 to maximize the number of VMs 604 instantiated.

Consider, further, how many sessions each gateway VNF 602a and each PCRF VNF 602b may support. This may factor into which assignment of resources 608 is more efficient. For example, consider if each gateway VNF 602a supports two million sessions, and if each PCRF VNF 602b supports three million sessions. For the first configuration—three total gateway VNFs 602a (which satisfy the gateway requirement for six million sessions) and two total PCRF VNFs 602b (which satisfy the PCRF requirement for six million sessions)—would support a total of six million sessions. For the second configuration—two total gateway VNFs 602a (which satisfy the gateway requirement for four million sessions) and five total PCRF VNFs 602b (which satisfy the PCRF requirement for 15 million sessions)—would support a total of four million sessions. Thus, while the first configuration may seem less efficient looking only at the number of available resources 608 used (as resources 608 for the tenth possible VM 604 are unused), the second configuration is actually more efficient from the perspective of being the configuration that can support more the greater number of sessions.

To solve the problem of determining a capacity (or, number of sessions) that can be supported by a given hardware platform 605, a given requirement for VNFs 602 to support a session, a capacity for the number of sessions each VNF 602 (e.g., of a certain type) can support, a given requirement for VMs 604 for each VNF 602 (e.g., of a certain type), a give requirement for resources 608 to support each VM 604 (e.g., of a certain type), rules dictating the assignment of resources 608 to one or more VMs 604 (e.g., affinity and anti-affinity rules), the chasses 610 and servers 612 of hardware platform 606, and the individual resources 608 of each chassis 610 or server 612 (e.g., of a certain type), an integer programming problem may be formulated.

As described herein, a telecommunications system wherein management and control utilizing a software defined network (SDN) and a simple IP are based, at least in part, on user equipment, may provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a telecommunications system in which machine learned security for computer program products can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims.

In describing preferred methods, systems, or apparatuses of the subject matter of the present disclosure—managing of machine learned security for computer program products—as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed subject matter, including making and using any devices or systems and performing any incorporated methods. The patentable scope is defined by the claims, and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

Methods, systems, and apparatuses, among other things, as described herein may provide for managing machine learned security for computer program products, which may create dynamic micro-perimeters. A method, system, computer readable storage medium, or apparatus may obtain a machine learning model; obtain a log of data traffic (also referred herein as traffic log), wherein the log of data traffic may include information associated with a first application; analyze the log of data traffic using the machine learning model; determine, based on the analysis used by the machine learning model, whether to alter security rules for the first application; and based on the determination to alter the security rules for the first application, send instructions to alter the security rules for the first application. The log of data traffic may include error information, type of data traffic information, or throughput information associated with the first application. Type of data traffic may include whether the data traffic includes user datagram protocol, transmission control protocol, HTTP, SMTP, FTP, IMAP, SSH, telnet, DNS, or the like. Type of data traffic may be based on port number. Instead of or in addition to the log of data traffic a percent of data traffic may be analyzed directly to make the determinations herein. The security rules may be altered in an application programming interface of the first application or in a virtual machine of the first application, a virtual firewall connected with the first application, or physical firewall connected with a device of first application. A method, system, computer readable storage medium, or apparatus may analyze historical data of logs for the first application; and based on the analysis, update the current machine learning model to a new machine learning model. A method, system, computer readable storage medium, or apparatus may obtain a traffic log, wherein the traffic log may be for a first application of a plurality of applications, wherein the traffic log is obtained periodically (e.g., every 10 minutes); determining, via a machine learning model, whether to alter the flow of traffic to or from the first application; based on determining that flow of traffic should be altered, sending instructions to a virtual machine or virtual network function that comprises the first application, wherein the virtual machine or virtual network function allows or denies traffic from other applications. There may be an API that is used to restrict execution of a particular command (or data traffic type) received, restrict any traffic received from a particular application (or network), restrict sending of a particular command to be executed to a particular application or network (or type of application or network). The resources that may be used to implement the security rules may include a virtual computer processing unit (vCPU), virtual network function, a network interface card (NIC), or computer memory, among other things. All combinations in this paragraph (including the removal or addition of steps) are contemplated in a manner that is consistent with the other portions of the detailed description.

What is claimed:

1. A method comprising:
obtaining a machine learning model;
obtaining a log of data traffic, wherein the log of data traffic comprises information associated with a first application;
analyzing the log of data traffic using the machine learning model;
determining, based on the analysis used the machine learning model, whether to alter security rules for the first application; and
based on the determination to alter the security rules for the first application, sending instructions to alter the security rules for the first application.

2. The method of claim 1, wherein the log of data traffic comprises error information or throughput information associated with the first application.

3. The method of claim 1, wherein the log of data traffic comprises type of data traffic during a period that flows to the first application from a second application.

4. The method of claim 1, wherein the security rules are altered in an application programming interface of the first application.

5. The method of claim 1, wherein the security rules are altered in a virtual machine associated with the first application.

6. The method of claim 1, wherein the security rules are altered in a firewall located between the first application and a second application.

7. The method of claim 1, the operations further comprising:
analyzing historical data of logs for the first application; and
based on the analyzing, updating the machine learning model to a new machine learning model.

8. The method of claim 1, wherein the security rule comprises denying traffic from a second application.

9. An apparatus comprising:
a processor; and
a memory coupled with the processor, the memory storing executable instructions that when executed by the processor cause the processor to effectuate operations comprising:
obtaining a machine learning model;
obtaining a log of data traffic, wherein the log of data traffic comprises information associated with a first application;
analyzing the log of data traffic using the machine learning model;
determining, based on the analysis used the machine learning model, whether to alter security rules for the first application; and
based on the determination to alter the security rules for the first application, sending instructions to alter the security rules for the first application.

10. The apparatus of claim 9, wherein the log of data traffic comprises error information or throughput information associated with the first application.

11. The apparatus of claim 9, wherein the log of data traffic comprises type of data traffic during a period that flows to the first application from a second application.

12. The apparatus of claim 9, wherein the security rules are altered in an application programming interface of the first application.

13. The apparatus of claim 9, wherein the security rules are altered in a virtual machine associated with the first application.

14. The apparatus of claim 9, wherein the security rules are altered in a firewall located between the first application and a second application.

15. The apparatus of claim 9, the operations further comprising:
analyzing historical data of logs for the first application; and
based on the analyzing, updating the machine learning model to a new machine learning model.

16. The apparatus of claim 9, wherein the security rule comprises denying traffic from a second application.

17. A computer readable storage medium storing computer executable instructions that when executed by a computing device cause said computing device to effectuate operations comprising:
obtaining a machine learning model;
obtaining a log of data traffic, wherein the log of data traffic comprises information associated with a first application;
analyzing the log of data traffic using the machine learning model;
determining, based on the analysis used the machine learning model, whether to alter security rules for the first application; and
based on the determination to alter the security rules for the first application, sending instructions to alter the security rules for the first application.

18. The computer readable storage medium of claim 17, wherein the log of data traffic comprises error information or throughput information associated with the first application.

19. The computer readable storage medium of claim 17, wherein the log of data traffic comprises type of data traffic during a period that flows to the first application from a second application.

20. The computer readable storage medium of claim 17, wherein the security rules are altered in an application programming interface of the first application.
